(19) United States
(12) Patent Application Publication
(10) Pub. No.: US 2021/0101251 A1
(43) Pub. Date: Apr. 8, 2021

(54) Apparatus and Method for Grinding and/or Polishing Flat Surfaces of Workpieces

(71) Applicant: Optikron GmbH, Jena (DE)

(72) Inventor: Gerrit SEYFFERT, Jena (DE)

(73) Assignee: Optikron GmbH, Jena (DE)

(21) Appl. No.: 17/061,579

(22) Filed: Oct. 2, 2020

(30) Foreign Application Priority Data
Oct. 2, 2019 (EP) 19 201 010.6

(51) Int. Cl. B24B 41/06; B24B 41/02; B24B 41/047

(52) U.S. Cl. CPC B24B 41/06; B24B 41/047; B24B 41/02

(57) ABSTRACT

The invention relates to a device (100) for the grinding and/or polishing of planar surfaces, comprising
a grinding and/or polishing tool (20),
a frame (40),
a workpiece (32) or a holder (30) for at least one workpiece, and
a means (10) for moving the frame and the workpiece holder (30) with the workpiece,
characterized in that
the device (100) is set up in such a way that a loose bearing is formed between the workpiece (32) or the workpiece holder (30) and the frame (40), and the means (10) for moving the frame (40) and the workpiece (32) or the workpiece holder (30, 30′) with the at least one workpiece (32) is configured in such a way that the workpiece (32) or the workpiece holder (30) with the at least one workpiece (32) is guided in a plane which is predetermined by the surfaces of the at least one workpiece (32) resting on the grinding and/or polishing tool (20).

The invention also relates to a method for the polishing of planar optics by using the device (100).

### FIELD OF THE INVENTION

The invention relates to a device for the grinding and/or polishing of planar surfaces, in particular planar surfaces of optical workpieces, comprising a grinding and/or polishing tool, a frame, a holder for at least one workpiece, and a means for moving the frame, characterized in that a workpiece or the workpiece holder with the at least one workpiece is arranged in the frame in such a way that a loose bearing is formed between the workpiece or the workpiece holder and the frame. The device is configured in such a way that movements of the means for moving the frame are transmitted from the frame to the workpiece or the workpiece holder with the at least one workpiece, so that the workpiece or the workpiece holder with a workpiece is guided in a plane which is predetermined by the surfaces of the workpiece resting on the grinding and/or polishing tool. The invention also relates to a method for the grinding and/or polishing of planar surfaces by using the device according to the invention.

### BACKGROUND OF THE INVENTION

Among the basic structures of classic optics are known structures such as lenses, prisms, polarizers, filters, phase plates, mirrors, diaphragms and gratings. The main focuses of attention for development and production are prisms, groups of prisms and mirrors, lenses and lens arrays (spherical and aspherical, cylindrical, one-dimensional rows and two-dimensional arrays) with a refractive or diffractive effect and also grid structures.

The range of materials for the production of optical structures is extremely broad and is also still being extended at the present time. The most important materials for use are glasses including quartz glass, polymers and silicon, as well as some crystals such as LiNbO₃ and also GaAs and GaP (the latter are suitable as a highly refractive material for wavelengths over 500 nm). In the case of polymers, the low costs for mass production is a decisive driving force. Silicon is a material of choice for mirrors and also for the infrared spectral range, since the high refractive index there produces optical advantages.

The optical function is obtained by shaping the homogeneous optical medium or by changing the refractive index of an optical substrate that is unchanged in its form (gradient index components, GRIN) or by a combination of the two methods.

Individual optical elements and lenses of glass (in particular prisms) with at least one planar surface are conventionally produced by the classic production methods (grinding, polishing) or by means of complex CNC machines. This involves the grinding of the raw material, in order for example to produce the form of a prism or a first radius of the two lens surfaces. The grinding comprises a step of coarse grinding and fine grinding. This is followed by the polishing of the optics, once again with very complex CNC machines or classic lever polishing machines. Grinding and polishing by hand is still a commonly used method for special optics. The polishing operation takes a few minutes to several hours, depending on the size, form and material of the optics. In the industrial production of optics there are some cases where robots have already been successfully used for some time for the polishing of spherical and aspherical lenses. These type of optics are however very varied in their production. It has not so far been possible for the robot methods that exist for the working of lenses to be used for planar surfaces, since they do not achieve a sufficient finish for the required planarity of the surfaces. The polishing movements and directions of classic lever machines cannot be freely configured, because the basic sequence of movements is predefined by the principle of the lever machine. It is not possible for cycles with entirely different forms of movement to be implemented, which in the case of some types of optics would be necessary for achieving the required surface finish. Polishing tools for lenses, as are known for example from DE 60202804 T2, have a toric polishing surface and are therefore only suitable for the polishing of concave or convex surfaces, but not for the polishing of planar surfaces.

Conventional automated systems for the polishing of planar surfaces, which require high precision, such as for example planar surfaces of optical components, are therefore either very complex and expensive or do not achieve the desired quality requirements. Although devices for polishing planar surfaces are known from similar technical areas, they are not suitable for the polishing of planar surfaces that require high precision, such as for example planar surfaces of optical components.

DE 60221502 T2 for example relates to a polishing device for restoring optical discs, for example CDs, DVDs, VDs and LDs, comprising a disc rotation device for rotating an optical disc, and a polishing mechanism for polishing the surface of the optical disc, the polishing mechanism having an elastic mechanism for elastically holding a polishing pad and the polishing pad having a polishing sheet. The elastic mechanism is structurally designed in such a way that the polishing sheet comes into contact with the surface of the optical disc with a pressure required for polishing. The structural design of the elastic mechanism cannot however be transferred to the polishing of planar optics.

DE 102014002844 A1 relates to a chemical-mechanical polishing pad, comprising a polishing layer having a polishing surface and a broad-spectrum endpoint detection window block having a thickness along an axis perpendicular to a plane of the polishing surface, wherein the broad-spectrum endpoint detection window block comprises a cyclic olefin addition polymer, wherein the broad-spectrum endpoint detection window block exhibits a uniform chemical composition across its thickness, wherein the broad-spectrum endpoint detection window block exhibits a spectrum loss of ≤40%, and wherein the polishing surface is adapted for polishing a substrate selected from a magnetic substrate, an optical substrate and a semiconductor substrate. This is a tool that has to be used together with a conventional polishing machine and with the associated disadvantages described above.

### DESCRIPTION OF THE INVENTION

The object of the invention was therefore to provide a device which is specifically suitable for grinding and/or polishing planar surfaces that require high precision, such as for example planar surfaces of optical components, and with which the disadvantages of conventional grinding and/or polishing machines for optical structures can be overcome.

The object of the invention is achieved by a device for the grinding and/or polishing of planar optics, in particular of precision planar optics, which has a grinding and/or polishing tool and a holder for a workpiece to be worked, the device having a frame, which is connected to a means for moving the frame. The frame has an opening, which contains the workpiece holder with at least one workpiece. The device according to the invention is set up in such a way that a loose bearing is formed between the workpiece holder and the frame. By contrast with conventional polishing machines or grinding machines for optical structures, the polishing tool and/or the grinding tool is preferably arranged as stationary and, likewise by contrast with conventional polishing or grinding machines for optical structures, the workpiece to be worked is not stationary but is moved over the polishing tool. Optionally, the polishing tool could also be movable, in particular additionally rotating. The workpiece holder with at least one workpiece is preferably guided in a plane which is predetermined by the surfaces of the at least one workpiece resting on the grinding and/or polishing tool. Particularly preferably, a horizontal movement of the workpiece holder with the at least one workpiece takes place.

In a preferred embodiment, the invention provides a device for the polishing and/or grinding of planar surfaces that require high precision, such as for example planar surfaces of optical components, comprising
a polishing and/or grinding tool,
a frame,
a holder for at least one workpiece, and
a means for moving the frame and the workpiece holder with the at least one workpiece
characterized in that
the device is set up in such a way that a loose bearing is formed between the workpiece holder and the frame, and the means for moving the frame and the workpiece holder with the at least one workpiece is configured in such a way that the workpiece holder with the at least one workpiece is guided in a plane which is predetermined by the surfaces of the at least one workpiece resting on the polishing and/or grinding tool.

The workpiece does not necessarily have to be contained in a workpiece holder, but instead, if of an appropriate size, may also be contained directly in the frame and be moved with it by the means for moving the frame.

In a preferred embodiment, the invention therefore provides a device for the grinding and/or polishing of planar surfaces, comprising
a grinding and/or polishing tool,
a frame,
a workpiece or a holder for at least one workpiece, and
a means for moving the frame with the workpiece or the workpiece holder with the at least one workpiece,
characterized in that
the device is set up in such a way that a loose bearing is formed between the workpiece or the workpiece holder with the at least one workpiece and the frame, and the means for moving the frame and the workpiece or the workpiece holder with the at least one workpiece is configured in such a way that the workpiece or the workpiece holder with the at least one workpiece is guided in a plane which is predetermined by the surfaces of the at least one workpiece resting on the grinding and/or polishing tool.

The planar surfaces to be worked are preferably planar surfaces of optical components, more preferably planar optics and particularly preferably precision planar optics or planar micro-optics, and are for example selected from optical prisms, wedges, rods, plates, etc. However, the device according to the invention is also suitable in principle for the polishing or grinding of any type of planar surfaces for which a high surface finish matters, such as for example optical discs, for example CDs, DVDs, VDs and LDs, or wafers from the semiconductor industry. The device according to the invention is particularly well-suited for the polishing and/or grinding of planar micro-optics. The device according to the invention can additionally be used for the grinding and/or polishing of any type of planar surfaces, also in other technical areas outside of optics and the semiconductor industry. Since the choice of polishing or grinding tool is freely selectable, it is also the case that any type of material on which surface machining can be performed can be ground or polished with the device according to the invention.

In principle, any means that is capable of guiding the workpiece holder with at least one workpiece in a plane which is predetermined by the surfaces of the workpiece resting on the polishing and/or grinding tool is suitable as the means for moving the frame that contains the workpiece holder with the at least one workpiece.

The means for moving the frame that contains the workpiece holder with the at least one workpiece may be for example a classic lever machine. However, the type and direction of movement of the frame, and consequently of the workpiece holder with the at least one workpiece, is predefined by the lever machine, and is therefore restricted. The means for moving the frame that contains the workpiece holder with the at least one workpiece is therefore preferably free with regard to the configuration of the polishing and/or grinding movements and makes it possible to implement movement cycles with very varied forms of movement in one plane, which is not possible with the classic lever machines. Furthermore, the achievable surface finish, the polishing time and consequently the efficiency are positively influenced by the configuration of the forms of movement that take place in one plane.

What is meant by the “plane” in which these forms of movement are configured is the plane in which the at least one workpiece is guided over the polishing and/or grinding tool. In a particularly preferred embodiment of the invention, the at least one workpiece is guided horizontally over the polishing and/or grinding tool, i.e. the surface to be worked of a planar optics is guided with high precision parallel to the surface of the polishing and/or grinding tool. The implementation of these desired movement cycles is achieved for example by a device with axes that are moved in an automated manner (CNC machine) or a robot having a robot arm that serves as a means for moving the frame with the workpiece or workpiece holder arranged movably therein. Therefore, according to the invention, the means for moving the frame in which the workpiece or the workpiece holder with the at least one workpiece is movably arranged is preferably a CNC machine or a robot with a robot arm or some other device with axes that are moved in an automated manner Particularly preferred in this connection is a robot with a robot arm. The desired movement cycles and sequences of movement are controlled by a control program, which is executed in the control unit of the means for moving the frame. Control programs for controlling CNC machines, industrial robots and other suitable mechanisms for moving the frame of the device according to the invention are known to a person skilled in the art.

The workpiece holder may be set up for receiving an individual workpiece for carrying out the grinding and/or polishing method. In dependence on the size of the workpieces to be worked, it has proven to be expedient to provide the workpiece holder with a carrying body, which is suitable for receiving a number of workpieces. This has the advantage that, as a result, a number of workpieces, in the case of planar micro-optics even very many workpieces, can be worked at the same time.

In a particularly preferred embodiment, the invention therefore provides a device for the polishing of planar surfaces, in particular precision planar optics, comprising
a CNC machine or a robot with a robot arm,
a polishing and/or grinding tool,
a frame, which is connected to the CNC machine or the robot arm of a robot, and
a workpiece or a holder for at least one workpiece,
characterized in that
the frame loosely contains the workpiece or the workpiece holder with at least one workpiece and, as a result, a loose bearing is formed between the frame and the workpiece or the workpiece holder with the workpiece, and the CNC machine or the robot with the robot arm is configured in such a way that the workpiece or the workpiece holder with a workpiece or a carrying body with a number of workpieces is guided in a plane which is predetermined by the surfaces of the workpiece or the workpieces resting on the polishing and/or grinding tool.

In connection with the moving of the workpiece on the polishing and/or grinding tool, the device according to the invention can also be used to generate very specifically sequences of movements which replicate purely linear or very slightly curved movements. In particular, the rotating of the workpiece (mechanically enforced) can consequently be avoided. The movements caused by the CNC machine or the robot therefore allow the device according to the invention to create very flexibly paths and sequences of movements with which the forces in each case act only in the desired preferential directions. What is more, the speeds in various stages of movement can be varied.

In the context of the invention, a “loose bearing” is not an actual component, but is defined by the frame, which is connected to the means for moving the frame, and the workpiece holder. The frame has an opening of any desired geometrical form. The workpiece holder is movably arranged in this opening. The workpiece holder is therefore not fixedly connected to the frame. The workpiece holder is guided by the movements of the frame, i.e. the frame transmits the movements of the means for moving the frame (lever machine, CNC machine, robot) to the workpiece holder. This ensures that the workpiece holder can perform movements in space in one or two of the three directions. Preferably, this construction allows movements of all kinds (linear, curved and rotational movements) of the workpiece holder with at least one workpiece or with a carrying body with a number of workpieces in just one plane. This arrangement is particularly advantageous, since rotations of the workpiece holder, and consequently of the at least one workpiece, out of the horizontal plane (i.e. lateral canting of the workpiece holder and of the workpieces) are prevented, or are only produced very specifically, by set paths. Instead of the workpiece holder, there is also the possibility of introducing a workpiece into the frame directly, in a loose manner, and for it to be guided therein for working.

The embodiments of the device according to the invention described so far have the advantage that the polishing or grinding of the planar surface of the workpiece is performed with the highest precision and even slight vertical deflections of the robot arm and also disruptive force effects are not transmitted to the workpiece holder with the workpiece, and consequently undesired pressure and the deflection of the workpiece or the workpiece holder with the workpiece out of the horizontal plane is effectively prevented. Consequently, finishes of the surfaces that meet the requirements for planar optics are achieved. What is more, gentle working is obtained, with which also micro-optics and other sensitive components can be worked.

The problem with conventional polishing machines is that minor deflections of the polishing tool in all three spatial directions cannot be completely prevented, since in the case of conventional polishing machines not only is the workpiece moved, but also the polishing tool itself. Only the horizontal deflection in two spatial directions in one plane is desirable. To the same extent, it cannot be completely prevented that, due to the means for moving, in this case the polishing machine, a direct force effect of the polishing tool, in particular vertical pressure, occurs to varying degrees on the workpiece. The force effect or pressure effect cannot be completely controlled, in particular cannot be set to constant values. These disadvantages of the prior art are likewise overcome by the device according to the invention. The vertical exertion of force or pressure on the workpiece can be prevented by appropriate programming or configuration of the robot.

In a further embodiment, the device according to the invention is therefore characterized in that the robot is configured in such a way that no vertical exertion of force or pressure on the workpiece by the robot arm can take place. In the context of the invention, pressure is understood as meaning the result of a force F acting perpendicularly or obliquely from above on a surface area A, the surface area A being intended to mean the planar surface of the workpiece that is to be polished.

The transmission of undesired deflections of the robot arm to the workpiece is prevented according to the invention by the workpiece holder not being fixedly connected to the means for moving, but instead being movably contained in the frame and guided by it. For more precise transmission of the movements of the frame to the workpiece holder, it has proven to be expedient if the frame contains means for guiding the workpiece holder.

In a further embodiment, the device according to the invention is therefore characterized in that the workpiece or the workpiece carrier is arranged loosely, i.e. movably, in the frame and the frame has lateral abutments for guiding the workpiece. The lateral abutments for guiding the workpiece holder preferably consist of an elastic and/or shock-absorbent material, which particularly preferably does not produce any abrasion or only slight abrasion. A suitable material is for example felt. Any other materials, including hard materials, that allow vertically directed sliding of the workpiece or workpiece holder in the frame, and consequently ensure the loose seating preferably in the horizontal direction, are suitable. In addition, it is of advantage if the frame is configured in such a way that the workpiece or the workpiece holder with at least one workpiece is secured in the frame against twisting.

Alternatively, the lateral abutments for guiding the workpiece holder may also be attached to the workpiece holder itself.

According to the invention, one or more workpieces may be contained in the workpiece holder or a carrying body, for example 1 to 10 workpieces or, in the case of smaller parts, such as for example micro-optics, up to several hundred workpieces.

In the way described, the opening of the frame, in which the workpiece or the workpiece holder is movably contained, may have any desired geometrical form that is suitable for preventing the twisting of the workpiece holder out of the horizontal plane, i.e. the canting of the workpiece holder. In a particularly preferred embodiment of the invention, the frame therefore has a rectangular, trapezoidal, polygonal, elliptical or any other form. As a result, implementation of movement cycles with very varied forms of movement of the workpiece holder with at least one workpiece in one plane, and skilled configuration of the forms of movement (linear, curved and rotational movements) that are to take place in a plane is possible without erroneous movements of the frame in an undesired plane (such as for example twists out of the horizontal plane), which are produced by erroneous movements of the means for moving the frame, being transmitted to the workpiece holder, and consequently to the at least one workpiece.

In order to achieve the specified surface finish of a surface to be ground or polished, in particular of a planar optics, it may be necessary to control exactly the movement of the workpiece holder with the workpiece. In a further embodiment of the invention, the device according to the invention is therefore configured to perform the movement of the workpiece holder with the workpiece in exactly predefined paths by way of the frame.

As mentioned above, the effect of pressure acting to varying degrees on the workpiece leads to undesired losses of quality of the finish of the planar surface of the workpiece. This problem can be solved by the pressure that acts on the workpiece and/or the workpiece holder being controlled, preferably kept constant. With the device according to the invention, this is achieved in a very easy way by the weight of the workpiece or the workpiece with the workpiece holder, and possibly the carrying body for a number of workpieces, being used for producing the required pressure, or by additionally applying to the workpiece holder with the workpiece a weight which has a desired mass and which is moved together with the workpiece holder and the workpiece. In a further embodiment of the invention, the device is therefore configured to exert the pressure required for performing the polishing operation by the weight of the workpiece itself, directly by the workpiece holder, and optionally by a weight applied to the workpiece and/or workpiece holder.

It may also have a disadvantageous effect on the finish of the surface of the planar optics if the workpiece begins to rotate due to the performance of the movements during the grinding or polishing. In a further embodiment of the invention, the device is therefore configured to avoid enforced rotation of the workpiece. This is achieved for example by the aforementioned geometrical form of the opening of the frame (rectangular, trapezoidal, polygonal or elliptical) and a corresponding geometrical form of the part of the workpiece holder that is movably arranged in the frame.

In the context of the invention, “loosely or movably contained” means that the workpiece holder on the one hand is not fixedly connected to the frame and the geometrical form of the opening of the frame substantially coincides with the geometrical form of the part of the workpiece holder that is arranged in the opening of the frame. Preferably, the distance between the opening of the frame and the outer edges of the part of the workpiece holder that is arranged in the opening of the frame is minimal and just large enough that jamming of the workpiece holder in the frame is avoided. The distance (peripherally) between the opening of the frame or the guides provided there for the workpiece holder and the outer edges of the part of the workpiece holder that is contained in the opening of the frame may be for example between 0.01 and 10 mm, preferably between 0.1 and 5 mm, particularly preferably between 0.1 and 2 mm or between 0.1 and 1 mm.

As already described, the device according to the invention comprises a grinding tool and/or a polishing tool.

In principle, any type of grinding tool that is suitable for grinding planar surfaces of optical structures can be used in the device according to the invention. Preferably the grinding tool is a grinding wheel. Suitable grinding tools, in particular grinding wheels, are known to a person skilled in the art from the prior art.

In principle, any type of polishing tool that is suitable for polishing planar surfaces of optical structures can be used in the device according to the invention. Preferably, the polishing tool is a polishing wheel. Suitable polishing tools, in particular polishing wheels, are known to a person skilled in the art from the prior art.

The polishing tool and the grinding tool may also be identical. The desired surface finish of the workpiece can then be achieved for example by selection of suitable grinding and polishing agents, which are known to a person skilled in the art.

The invention also relates to a method for the grinding and/or polishing of planar surfaces, in particular precision planar optics, with the aid of the device according to the invention. In a preferred embodiment, the method comprises the steps of:
introducing a workpiece or a workpiece holder with the at least one workpiece into a frame, which is connected to a means for moving the frame, which optionally has lateral abutments for guiding the workpiece holder;
moving the frame with the workpiece or the workpiece holder, which contains at least one workpiece, by the means for moving the frame in one plane, which is predetermined by the surfaces of the workpiece resting on a grinding and/or polishing tool; and
producing a ground and/or polished planar surface of the workpiece;

characterized in that the workpiece or the workpiece holder forms a loose bearing with the frame, the workpiece holder being movably contained in the opening of the frame and twists of the workpiece or of the workpiece holder with the at least one workpiece, in particular out of the horizontal resting plane of the workpieces, being avoided.

The preferred refinements and advantages of the device according to the invention equally apply to the method according to the invention, and so reference is made to what has been said above.

The method according to the invention is characterized in particular in that the pressure required for performing the grinding and/or polishing operation is exerted by the weight of the workpiece itself, directly by the workpiece holder, and optionally a weight applied to the workpiece and/or workpiece holder, if applicable with a carrying body for a number of workpieces, this applied weight not coming into contact with the frame. This refinement additionally assists the mobility of the workpiece holder in the frame and avoidance of the transmission of undesired movements of the frame to the workpiece holder.

In a further embodiment of the invention, the method is characterized in that the movement of the workpiece or the workpiece holder with the workpiece is performed in exactly predefined paths by way of the frame of the device according to the invention.

A further advantage of the invention is that both the device according to the invention and the method according to the invention are suitable for the grinding and/or polishing of a wide variety of materials of which optical structures usually consist, such as glasses including quartz glass, polymers and silicon, as well as some crystals such as LiNbO₃ and also GaAs and GaP. The method according to the invention is suitable in principle for the grinding and/or polishing of any type of materials on which mechanical surface working can be performed.

Usually, mechanical and/or chemical polishing agents are used for the operation of grinding and/or polishing optical structures. Such polishing agents are known to a person skilled in the art and are not the subject of the present invention. In principle, all grinding agents and polishing agents suitable for the grinding or polishing of optical structures can be used with the device according to the invention and in the method according to the invention.

The device according to the invention and the method according to the invention preferably provide planar micro-optics and planar optics, and also planar surfaces on other types of optics and parts (for example also on lenses or technical metal or ceramic parts), the surface finish of which achieves a new, previously unknown quality. The invention therefore relates in a further embodiment to planar optics, lenses with a planar surface, wafers or any other type of glass, metal, plastic or ceramic parts with at least one planar surface that has been produced by the device according to the invention or by the method according to the invention.

The invention provides an advantageous device and an advantageous method for the grinding and/or polishing of planar surfaces which require high precision on the basis of a unique construction for the attachment of the workpiece by way of a frame and a special workpiece holder and also special sequences of movements. With the method according to the invention and the device according to the invention, very sensitive planar optics and those with a high-quality finish can be ground and polished with very high efficiency. The method according to the invention in combination with the developed frame and the attachment of the workpiece holder by forming a loose bearing is suitable for the industrial production of precision planar optics that are used in a wide variety of applications in a broad range. According to the current state of the art, in the industrial sector these optics are ground or polished either with classic machines (lever polishing machines) or with very complex CNC machines, the disadvantage being that undesired movements of the classic machines are transmitted directly to the grinding or polishing tools, as a result of which the quality of the ground or polished planar optics cannot meet the highest requirements. Very sensitive planar optics are therefore often still polished at least partially by hand. The newly developed method can preferably be carried out by a collaborative robot from the price range of currently about €30 000. The investment expenditure is consequently significantly less than for the CNC technology often used at present, where machine investment often exceeds €150 000. Added to this is the fact that more convenient control makes it easier to program the sequence of movements on the robot and it is already possible after comparatively straightforward instruction and training. Operating the robot according to the invention does not require a trained CNC specialist, which is very advantageous given the current lack of skilled labour in these occupational groups. In comparison with grinding and/or polishing with classic lever machines, there is a very significant difference in the type of movement, and consequently in the mechanical stressing of the workpieces. With the novel use of the robot, there is absolute freedom in the configuration of the grinding and/or polishing movements and cycles with very different forms of movement can be implemented, which is not possible with the classic lever machines. They offer only very few possibilities, because the basic sequence of movements is predefined by the principle of the lever machine. It has however surprisingly been found that, precisely by skilful configuration of the forms of movement with which the workpiece is guided over the grinding and/or polishing tool, the quality of the achievable surface finish, the working time and consequently the efficiency can be influenced very greatly. In this respect, the developed robot process brings with it an additional range of possibilities for increasing the quality of the finish and the efficiency. Furthermore, the grinding and/or polishing process on lever machines is not suitable for certain types and dimensions of planar optics, because the mechanical forces that act on the workpieces due to the movements that are predefined on these machines are too high, which leads to damage. The robot polishing process preferred according to the invention provides the possibility specifically for these more sensitive parts also to be ground and/or polished by machine and even in an automated manner Since the investment costs for a classic lever machine are as much as the price of the robot, here too the stated advantages of the novel robot process are very predominant in comparison.

In industrial optics production, robots have for some time already been successfully used occasionally in another area, in the polishing of spherical and aspherical lenses. These types of optics are however very varied in their production processes. The robot methods that exist for lens working could not so far be used for planar optics, since they do not achieve a sufficiently high-quality finish for the achievable surface planarity. With the device according to the invention, and specifically as a result of the frame and the attachment of the workpiece holder to the robot by way of the frame, this problem has now been solved and it is now possible with the device according to the invention and the method according to the invention also for planar optics to be ground and polished with the required finish and efficiency in an automated manner by industrial robots.

The loose bearing formed between the workpiece holder or the workpiece itself and the frame fastened to the robot arm has the effect of isolating the undesired influences by the robot or other means for moving the frame. This applies in particular to the pressure (completely loose substantially in the vertical axis=>only “loose” lateral guidance without a firm grip and without pressure). The robot only guides the workpiece on the grinding and/or polishing tool in one plane, which is predetermined by the surfaces of the workpiece resting on the grinding and/or polishing tool (guidance by lateral abutments on the frame, fitting loosely, i.e. movably, in the frame of the device=>but secured against twisting), without exerting pressure itself. The workpiece or the workpieces with their carrier are fitted loosely or fixedly in the workpiece holder, which in turn is secured by the geometrical form of the opening of the enclosing frame (form of the opening of the frame for example rectangular, trapezoidal, polygonal, elliptical etc.) against twisting. The frame is fastened to the robot and the guidance of the workpiece holder and of the workpieces contained therein in the desired path is realized by way of the frame. The required pressure is produced by the weight of the workpiece itself, directly by the workpiece holder and/or a weight optionally applied to it, which exerts uniform pressure on the workpiece. This achieves the required high planarities that are decisive for planar optics and other planar surfaces, without the robot “mis-pressing” or unevenly pressing them, which would otherwise occur due to the errors in the axes, in the relative alignment and in the series of movements of the robot. In addition, sequences of movements that proceed along very precisely defined paths and with which “enforced rotation” of the workpiece is avoided can be generated. Such “enforced rotation” occurs in the case of the classic lever machines, which is sometimes also desired there, albeit for other applications. For parts with specific forms or greater sensitivity, such as planar micro-optics, such “enforced rotation” however often means excessive mechanical stressing, which can lead to parts becoming detached from the assembly, and consequently the entire arrangement being “destroyed”. The robot movements allow paths and sequences of movements with which the forces only act in each case in the desired preferential directions and with which speeds can be individually optimized to be predefined very specifically.

The invention is explained in more detail below on the basis of 6 figures, in which:

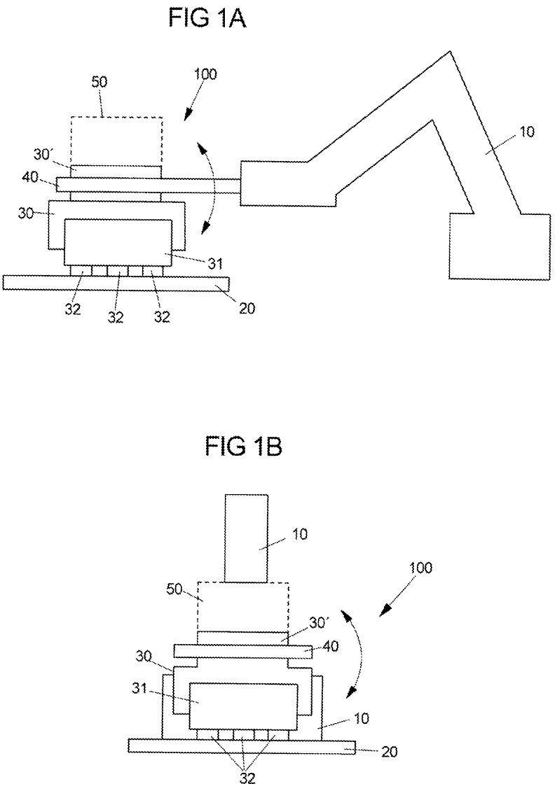

FIG. 1 shows a schematic representation of the device according to the invention;

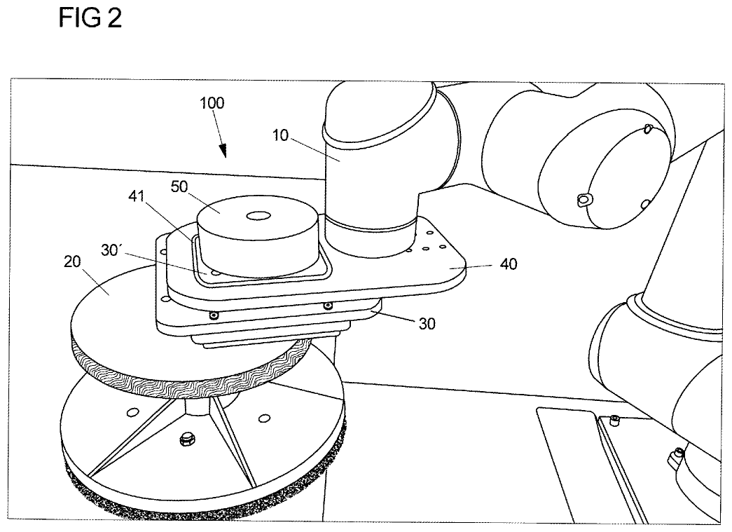

FIG. 2 shows an embodiment of the device according to the invention with a robot;

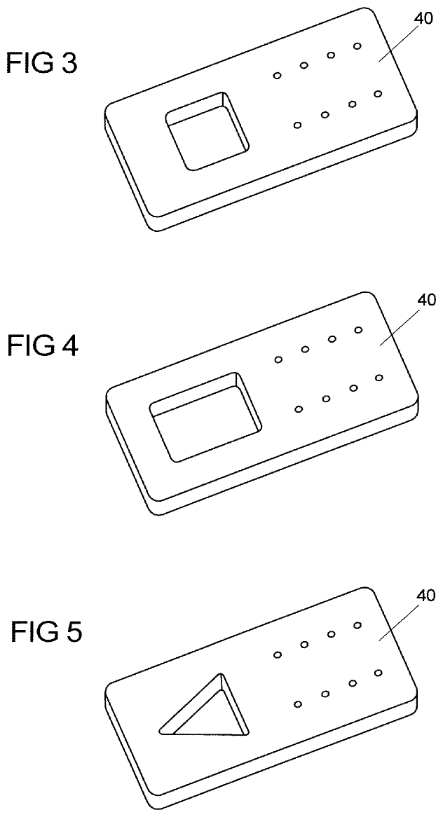

FIG. 3 shows an embodiment of the frame with a square opening;

FIG. 4 shows an embodiment of the frame with a rectangular opening;

FIG. 5 shows an embodiment of the frame with a triangular opening;

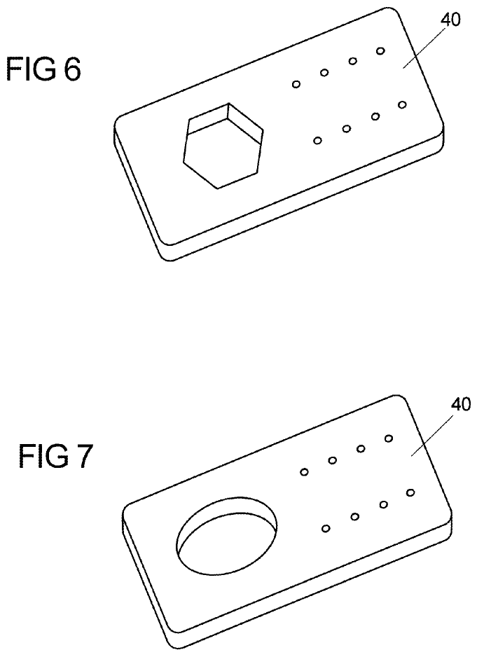

FIG. 6 shows an embodiment of the frame with a hexagonal opening;

FIG. 7 shows an embodiment of the frame with an elliptical opening;

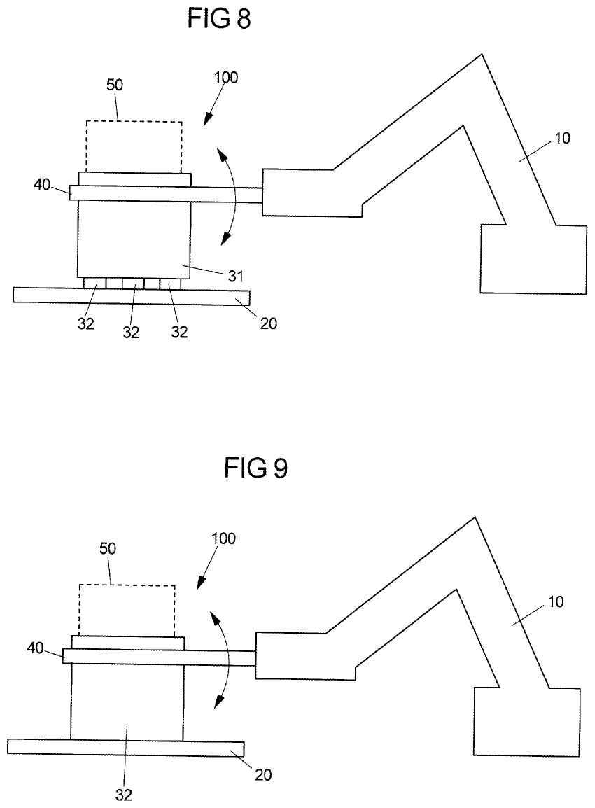

FIG. 8 shows a schematic representation of a further embodiment of the device according to the invention; and

FIG. 9 shows a further schematic representation of a further embodiment of the device according to the invention.

FIG. 1 schematically shows an embodiment of the device 100 according to the invention in a side view (FIG. 1A) and in a front view (FIG. 1B), comprising a frame 40 and a workpiece holder 30 with a workpiece 32 or a number of workpieces 32 to be ground or to be polished on a tool carrier or carrying body 31 and a grinding and/or polishing tool 20. The workpiece holder 30 forms a loose bearing with the frame 40, i.e. the workpiece holder 30 has an upper part 30′, which is arranged in the frame 40. The upper part 30′ of the workpiece holder is not fixedly connected to the frame 40, but instead protrudes into the opening of the frame 40 and is movably arranged in the opening of the frame 40. The frame 40 is connected to a means 10 for moving the frame 40. The movements of the frame 40 are transmitted by way of the upper part 30′ of the workpiece holder 30 to the workpiece holder 30, the carrying body 31 connected thereto and the workpieces 32. In the embodiment shown here, the means 10 for moving the workpiece holder 30 is the arm of a robot. Instead of a robot, however, a CNC machine or a classic lever machine could also be used. The workpieces 32 are arranged on the carrying body 31. The carrying body 31 or an individual workpiece 32 may be arranged loosely, but preferably fixedly, in the workpiece holder 30. For exerting the necessary pressure on the workpieces 32 during the grinding and/or polishing operation, the device 100 may optionally contain a weight 50, which is attached on the upper part 30′ of the workpiece holder in such a way that any contact with the frame 40 is avoided. By this configuration of the device 100, undesired twists (indicated by the curved double-headed arrow) of the workpiece holder 30 with the carrying body 31 and workpieces 32 out of the horizontal plane (i.e. canting of the workpiece holder 30) during the grinding and/or polishing operation are advantageously avoided.

FIG. 2 shows an embodiment of the device 100 according to the invention as in FIG. 1. In the embodiment shown here, the means 10 for moving the frame 40 is the arm of a robot. The frame 40 has a square opening, in which the upper part 30′ of the workpiece holder 30 with at least one workpiece is arranged. The frame 40 comprises lateral abutments 41 for guiding the workpiece holder 30 or the upper part 30′ thereof. The upper part 30′ has a geometrical form that is substantially identical to the form of the opening of the frame 40, therefore square in the case shown here. The distance between the opening of the frame 40 and the outer edges of the upper part 30′ of the workpiece holder 30 is minimal and just large enough that the upper part 30′ of the workpiece holder 30 is freely movable in the opening of the frame 40 and jamming of the upper part 30′ in the frame 40 is avoided. In the embodiment shown here, guides 41 for the upper part 30′ of the workpiece holder 30 of a shock-absorbing material are attached to the opening of the frame 40. The distance (peripherally) between the opening of the frame 40 or the guides 41 attached there and the outer edges of the upper part 30′ of the workpiece holder 30 is in the present case approximately 1 mm.

It is ensured by the square opening of the frame 40 that rotation of the workpiece holder 30, and consequently of the workpieces 42, enforced by the movement operation is avoided. The robot arm 10 is configured in such a way that the workpiece holder 30 with one or more workpieces is guided horizontally in a plane which is predetermined by the surfaces of the workpieces resting on the grinding and/or polishing tool 20. In this case, various movements can be performed in various directions within this plane. Corresponding movement cycles can be programmed in the control unit of the robot 10. In the present embodiment, the grinding and/or polishing tool 20 is formed as a wheel. The necessary pressure for pressing the workpieces onto the grinding and/or polishing tool 20 is applied in the embodiment shown in FIG. 1 by a steel weight 50, which is arranged on the workpiece holder 30. There is accordingly uniform application of a constant pressure.

FIGS. 3 to 7 show designs of the frame 40 with differently designed forms of the opening for receiving the workpiece holder 30, 30′, the workpiece carrier 31 or a workpiece 32. In principle, the opening of the frame 40 may have any desired geometrical form that is suitable for preventing twisting of the workpiece holder 30 and the upper part 30′ thereof in the frame 40 and canting of the workpiece holder out of the horizontal plane. The eight smaller holes shown in FIGS. 3 to 7 serve for fastening the frame to the means for moving 10, preferably on a robot arm 10.

FIG. 8 shows a schematic representation of the device 100 according to the invention as in FIG. 1, but in an embodiment in which the workpiece carrier 31 with a number of workpieces 32 is loosely contained without an additional workpiece holder 30 directly in the frame 40 and is moved together with it.

FIG. 9 shows a schematic representation of the device 100 according to the invention as in FIG. 1, but in an embodiment in which a workpiece 32 is loosely contained without an additional workpiece holder 30 or without an additional workpiece carrier 31 directly in the frame 40 and is moved together with it.

### LIST OF DESIGNATIONS

10 Means for moving the workpiece holder, robot with a robot arm

20 Grinding and/or polishing tool

30 Workpiece holder

30′ Upper part of the workpiece holder

31 Workpiece carrier, carrying body

32 Workpiece

40 Frame

41 Lateral abutments for guiding the workpiece holder

50 Weight

100 Device

1. Device (100) for the grinding and/or polishing of planar surfaces, comprising
a grinding and/or polishing tool (20),
a frame (40),
a workpiece (32) or a holder (30) for at least one workpiece (32), and
a means (10) for moving the frame (40) with the workpiece (32) or the workpiece holder (30) with the at least one workpiece (32),
characterized in that
the device (100) is set up in such a way that a loose bearing is formed between the workpiece (32) or the workpiece holder (30) with the at least one workpiece (32) and the frame (40), and the means (10) for moving the frame (40) and the workpiece (32) or the workpiece holder (30, 30′) with the at least one workpiece (32) is configured in such a way that the workpiece (32) or the workpiece holder (30) with the at least one workpiece (32) is guided in a plane which is predetermined by the surfaces of the at least one workpiece (32) resting on the grinding and/or polishing tool (20).

2. Device (100) according to claim 1, the loose bearing being formed by the frame (40) having an opening in which the workpiece (32) or an upper part (30′) of the workpiece holder (30) is arranged, characterized in that the workpiece (32) or the upper part (30′) of the workpiece holder (30) is movably arranged in the opening of the frame (40) and the workpiece (32) or the upper part (30′) of the workpiece holder (30) is not fixedly connected to the frame (40).

3. Device (100) according to claim 1, characterized in that the means (10) for moving the frame (40) is selected from a robot with a robot arm, a CNC machine and some other device with automated axes.

4. Device (100) according to claim 1, characterized in that the means (10) for moving the frame (40) is configured in such a way that no vertical exertion of pressure on the workpiece (32) can take place.

5. Device (100) according to claim 1, characterized in that the frame (40) has lateral abutments (41) for guiding the workpiece (32) or the workpiece holder (30′, 30).

6. Device (100) according to claim 1, the frame (40) and the upper part (30′) of the workpiece holder (30) being configured in such a way that rotation of the workpiece holder (30) with the at least one workpiece (32) in the frame (40) that is enforced in the grinding and/or polishing operation is prevented, characterized in that the opening of the frame (40) and the upper part (30′) of the workpiece holder (30) have a substantially identical geometrical form.

7. Device (100) according to claim 6, characterized in that the opening of the frame (40) has a rectangular, trapezoidal, polygonal or elliptical or any other form that prevents twisting of the workpiece holder (30, 30′) in the opening of the frame.

8. Device (100) according to claim 6, characterized in that the distance between the opening of the frame (40) and the outer edges of the part of the upper frame (30′) of the workpiece holder (30) is minimal and made just large enough that jamming of the workpiece holder (30′, 30) in the frame is avoided.

9. Device (100) according to claim 1, characterized in that the device (100) is configured to perform the movement of the workpiece (32) or the workpiece holder (30) with the at least one workpiece (32) in exactly predefined paths by way of the frame (40).

10. Device (100) according to claim 1, characterized in that the device (100) is configured to exert the pressure required for performing the grinding and/or polishing operation by the weight of the workpiece itself, directly by the workpiece holder (30), and optionally by a weight (50) applied to the workpiece (32) and/or workpiece holder (30).

11. Device (100) according to claim 1, characterized in that the workpiece holder (30) contains a number of workpieces (32), which are arranged in a carrying body (31).

12. Device (100) according to claim 1, characterized in that the grinding and/or polishing tool (20) is a grinding and/or polishing wheel.

13. Method for the polishing of planar surfaces by using a device (100) according to claim 1, the method comprising the steps of:
introducing a workpiece (32) or a workpiece holder (30) with at least one workpiece (32) or a carrying body (31) into a frame (40), which is connected to means (10) for moving the frame (40), which optionally has lateral abutments (41) for guiding the workpiece holder;
moving the frame (40) with the workpiece (32) or the workpiece holder (30), which contains at least one workpiece (32) or a carrying body (31) with a number of workpieces (32), by the means (10) for moving the frame (40) in one plane, which is predetermined by the surfaces of the at least one workpiece (32) resting on a grinding and/or polishing tool (20); and
producing a ground and/or polished planar surface of the workpiece (32);
characterized in that the workpiece (32) or the workpiece holder (30) forms a loose bearing with the frame (40), the workpiece (32) or the workpiece holder (30, 30′) being movably connected in the opening of the frame (40) and twists of the workpiece (32) or of the workpiece holder (30) with the at least one workpiece (32), in particular out of the horizontal resting plane of the workpieces (32), being avoided.

14. Method according to claim 13, characterized in that the pressure required for performing the grinding and/or polishing operation is exerted by the weight of the workpiece (32) itself, directly by the workpiece holder (30) and if applicable by the carrying body (31), and optionally a weight (50) applied to the workpiece (32) and/or the workpiece holder (30).

15. Method according to claim 13, characterized in that the movement of the workpiece (32) or the workpiece holder (30) with the at least one workpiece (32) is performed in precisely predefined paths by way of the frame (40).
